(19) United States
(12) Patent Application Publication
(10) Pub. No.: US 2010/0143804 A1
(43) Pub. Date: Jun. 10, 2010

(54) ANODE ACTIVE MATERIAL FOR LITHIUM SECONDARY BATTERY, METHOD OF MANUFACTURING THE SAME, AND LITHIUM SECONDARY BATTERY INCLUDING THE ANODE ACTIVE MATERIAL

(75) Inventors: Sang-kook MAH, Seoul (KR); Han-su Kim, Seoul (KR); Yoon-sok Kang, Seongnam-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd, Suwon-si (KR)

(21) Appl. No.: 12/545,186

(22) Filed: Aug. 21, 2009

(30) Foreign Application Priority Data
Dec. 9, 2008 (KR) 10-2008-0124658

(51) Int. Cl. H01M 4/48; H01M 4/58; H01M 4/88

(52) U.S. Cl. 429/231.5; 429/231.95; 429/231.8; 252/182.1

(57) ABSTRACT

An anode active material includes a material alloyable with lithium coated with an oxide including lithium or coated with a complex of an oxide including lithium and an electrically conductive material. An anode of a lithium secondary battery includes the anode active material.

### CROSS-REFERENCE TO RELATED APPLICATIONS

This application claims the benefit of Korean Patent Application No. 10-2008-0124658, filed on Dec. 9, 2008, in the Korean Intellectual Property Office, the disclosure of which is incorporated herein in its entirety by reference.

### BACKGROUND

1. Field

One or more embodiments relate to an anode active material for a lithium secondary battery, a method of manufacturing the anode active material for a lithium secondary battery, and a lithium secondary battery including the anode active material.

2. Description of the Related Art

In general, a lithium metal may be used as an anode active material of a lithium battery. However, when the lithium metal is used in a lithium battery, dendrites may be formed, and thus, electrical shorts may be generated and the battery may explode. Accordingly, a carbon based material is widely used as an anode active material, instead of a lithium metal.

The carbon based material used as the anode active material of the lithium battery may include crystalline carbon such as graphite or artificial graphite or amorphous carbon such as soft carbon or hard carbon. Amorphous carbon has high capacity but also may have a high irreversibility in charging and discharging. Graphite, which is the main type of crystalline carbon used in lithium batteries, has a high theoretical limit capacity of 372 mAh/g, and may be thus used as an anode active material. However, since the theoretical limit capacity of graphite or a carbon based active material is not greater than 380 mAh/g, an anode active material formed of such material may not be desirable for high capacity lithium batteries.

### SUMMARY

One or more embodiments include an anode active material for a lithium secondary battery having high charge/discharge capacity and excellent capacity retention rate.

One or more embodiments include an anode employing the anode active material.

One or more embodiments include a lithium secondary battery employing the anode.

One or more embodiments include a method of manufacturing the anode active material.

Additional aspects will be set forth in part in the description which follows and, in part, will be apparent from the description, or may be learned by practice of the invention.

To achieve the above and/or other aspects, one or more embodiments may include an anode active material of a lithium secondary battery, including: a member consisting of a material alloyable with lithium; and a coating layer formed on the member, wherein the coating layer comprises an oxide comprising lithium.

To achieve the above and/or other aspects, one or more embodiments may include an anode active material for a lithium secondary battery, including: a member consisting of a material alloyable with lithium; and a coating layer formed on the member, wherein the coating layer comprises a complex of an oxide comprising lithium and an electrically conductive material.

To achieve the above and/or other aspects, one or more embodiments may include an anode employing the anode active material for a lithium secondary battery above.

To achieve the above and/or other aspects, one or more embodiments may include a method of manufacturing an anode active material for a lithium secondary battery, the method including: mixing and stirring MXₙ and LiOH, wherein M is a metal, X is a halogen atom or a C1 to C7 alkoxy, and n is an integer in a range of 3 to 6, to manufacture an oxide precursor comprising lithium; adding the oxide precursor comprising lithium to a member comprising a material alloyable with lithium and stirring and drying the resultant; and heat treating the dried resultant.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects will become apparent and more readily appreciated from the following description of the embodiments, taken in conjunction with the accompanying drawings of which:

FIG. 1 is a cross-sectional diagram schematically illustrating an active material for a lithium secondary battery, according to an embodiment; and

FIG. 2 is a cross-sectional diagram schematically illustrating an active material for a lithium secondary battery, according to another embodiment.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An anode active material of a lithium secondary battery according to the present embodiment includes: a member formed of a material alloyable with lithium; and a coating layer formed on the member, wherein the coating layer includes an oxide including lithium.

Metal-based or intermetallic compound-based anode active materials are being actively researched. For example, research into a lithium battery using a metal or half-metal, such as aluminum, germanium, silicon, tin, zinc, and lead, as an anode active material has been conducted. Since these materials have a high capacity and high energy density and may intercalate or deintercalate more lithium ions than anode active materials formed of carbon based materials, a battery having high capacity and high energy density may be manufactured using an anode active material formed of such materials. For example, pure silicon has a high theoretical capacity of 4017 mAh/g.

However, since cycle characteristics are relatively poor in pure silicon, compared with carbon based materials, a practical use of silicon as an anode active material has not yet been developed. In particular, when inorganic particles such as silicon or tin particles are used in an anode active material to absorb and emit lithium, the conductivity between active materials may be decreased due to a volume change during charging and discharging or the anode active material may become separated from an anode current collector. That is, the inorganic particles such as silicon or tin particles included in the anode active material absorb lithium during charging and expand in volume to about 300-400% of their original volume. In addition, when lithium is emitted during discharging, the inorganic particles contract. When such charging and discharging cycles are repeated, electric isolation may occur due to a generation of empty spaces between the inorganic particles and the active material, so that lifetime of the battery may rapidly decrease.

Accordingly, metal nanoparticles may be coated with carbon to form an anode active material. However, due to breakability characteristics of carbon, when the metal nanoparticles expand during charging, the carbon may be cracked at the same time and empty spaces may be generated between the carbon and the metal nanoparticles when the metal nanoparticles contract during discharging. Thus, the lifetime of the battery is not improved. Accordingly, as research into use of a material having higher strength than that of carbon is conducted, it has been discovered that a metal cover, ceramic or thermoplastic resin may be covered on a material including silicon.

In the present embodiment, when particles that are alloyable with lithium are used as an anode active material, a lifetime degradation due to contraction/expansion is prevented, and when an oxide including lithium is coated on an anode active material, initial efficiency and lifetime characteristics are improved, compared with when a simple oxide is used.

According to the present embodiment, the member formed of a material alloyable with lithium included in the anode active material for a lithium secondary battery may be selected from the group consisting of Si, SiOₓ (here, 0<x<2), an Si alloy, Sn, SnOₓ (here, 0<x≦2), an Sn alloy, and a mixture thereof and may be a particle having a size of about 5 to about 10,000 nm.

According to the present embodiment, the oxide including lithium may be represented by a formula LiₐM_{b}O (b/a ranges from about 0.5 to about 2).

According to another embodiment, the oxide including lithium may be generated by mixing MXₙ and LiOH to form an oxide precursor, and drying and heat treating the oxide precursor. Here, M is a metal, X is a halogen atom or C1 to C7 alkoxy, and n is an integer in a range of 3 to 6.

According to another embodiment, M may be selected from the group consisting of Al, Si, Ti, and Zr, and the oxide including lithium may be, for example, LiₓAl_{y}O, LiₓSi_{y}O, LiₓTi_{y}O, and LiₓZr_{y}O (the value of y/x ranges from about 0.5 to about 2).

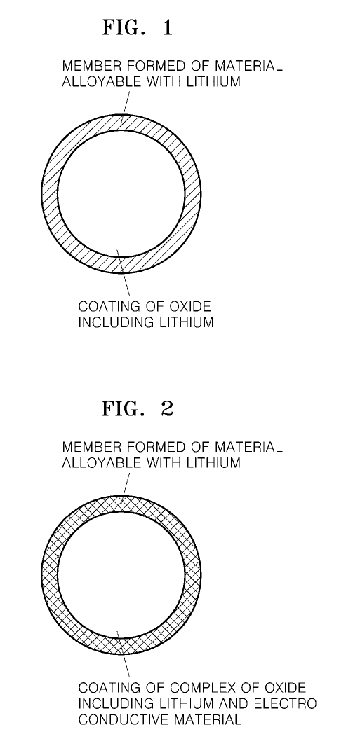

FIG. 1 is a cross-sectional diagram schematically illustrating an anode active material for a lithium secondary battery, according to an embodiment.

Referring to FIG. 1, the anode active material for a lithium secondary battery according to the present embodiment includes a member formed of a material alloyable with lithium, wherein the member is coated with an oxide including lithium.

In addition, the member formed of a material alloyable with lithium may be partially coated on a support or grown from a support or a thin film.

When the member formed of a material alloyable with lithium is coated by an oxide generated by chemically wetting an oxide precursor including lithium, the anode active material illustrated in FIG. 1 may be formed. Since the oxide has higher strength than that of carbon, a volume change in the anode active material due to charging and discharging may be reduced and lithium may be movable within the oxide.

Alternatively, the member formed of a material alloyable with lithium may be coated with the oxide including lithium using a mechanical process. When coating is performed using a mechanical process, the coating material may be partially bonded chemically to the material alloyable with lithium, but the bonding degree is much lower than when the wetting process is used. The volume change of the anode active material with respect to charging and discharging is greater when the mechanical process is used than when the wetting process is used.

An anode active material according to another embodiment may include: a member formed of a material alloyable with lithium; and a coating layer formed on the member, wherein the coating layer includes a complex of an oxide including lithium and an electrically conductive material. The material alloyable with lithium may be selected from the group consisting of Si, SiOₓ (here, 0<x<2), an Si alloy, Sn, SnOₓ (here, 0<x≦2), an Sn alloy, and a mixture thereof and may be a particle having a size of about 5 to about 10,000 nm.

According to an embodiment, the coating layer formed of the complex of the oxide including lithium and the electrically conductive material may be a complex of the oxide including lithium represented by a formula LiₐM_{b}O (the value of b/a ranges from about 0.5 to about 2) and carbon or a complex of the oxide including lithium represented by the formula LiₐM_{b}O (b/a ranges from about 0.5 to about 2) and a conductive metal.

According to another embodiment, the coating layer formed of the complex of the oxide including lithium and the electrically conductive material may be generated: by mixing MXₙ and LiOH to form an oxide precursor, mixing the oxide precursor and a carbon precursor, and drying and heat treating the mixture. Alternatively, the coating layer may be formed by coating the member formed of a material alloyable with lithium with an oxide precursor including lithium, drying the member coated with the oxide precursor including lithium, mixing a carbon precursor and the dried member, and drying and heat treating the mixture. Alternatively, the coating layer may be formed by mixing MXₙ and LiOH to form an oxide precursor, mixing the oxide precursor and a conductive metal, and drying and heat treating the mixture (here, M is a metal, X is a halogen atom or a C1 to C7 alkoxy, and n is an integer in a range of 3 to 6.

According to another embodiment, M may be selected from the group consisting of Al, Si, Ti, and Zr and the oxide including lithium may be, for example, LiₓAl_{y}O, LiₓSi_{y}O, LiₓTi_{y}O, and LiₓZr_{y}O y/x ranges from about 0.5 to about 2).

FIG. 2 is a cross-sectional diagram schematically illustrating an anode active material for a lithium secondary battery, according to another embodiment. Referring to FIG. 2, the anode active material includes a member formed of a material alloyable with lithium, wherein the member is coated with a complex of an oxide including lithium and an electrically conductive material.

In this case, carbon, which is electrically conductive, or a conductive metal, is mixed with the surface of an oxide precursor including lithium or into the coating layer, thereby increasing the conductivity of the coating layer of the active material.

An anode according to an embodiment includes the anode active material. As a non-limiting example, the anode may be manufactured by forming an anode active material composition including the anode active material and a binder into a specific shape or by coating the anode active material composition onto a current collector such as a copper foil.

More specifically, the anode active material composition may be manufactured and directly coated onto the copper foil current collector to obtain an anode plate. Also, the anode active material composition may be prepared and then cast onto a separate support, and then a composite anode active material film peeled from the support may be laminated onto the copper foil current collector to obtain an anode plate. The anode is not limited thereto and many other modifications may exist.

High capacity batteries typically charge and discharge large amounts of current, and thus, it is desirable to use a material having low electric resistance in high capacity batteries. In order to reduce the resistance of the electrodes, various conductive materials may be added to the electrodes. For example, the conductive materials may include carbon black or graphite fine particles. The anode active material composition may be printed on a flexible electrode plate and may be used to manufacture a printable battery.

A lithium battery according to an embodiment may be manufactured in the following manner.

First, a cathode active material, a conductive material, a binder, and a solvent are mixed to prepare a cathode active material composition. The cathode active material composition is directly coated onto a metallic current collector and is dried to prepare a cathode plate. In an alternative embodiment, the cathode active material composition is cast onto a separate support and detached from the support to obtain a cathode active material film. Then, the cathode active material film is laminated on the metallic current collector to prepare a cathode plate.

The cathode active material may be any lithium-containing metal oxide that is commonly used in the art. Examples of the lithium-containing metal oxide may include LiCoO₂, LiMnₓO₂ₓ(x=1, 2), LiNi₁₋ₓMnₓO₂ (0≦x≦1), or LiNi_{1-x-y}CoₓMn_{y}O₂ (0≦x≦0.5, 0≦y≦0.5). More specifically, the lithium-containing metal oxide may be a compound capable of intercalation and deintercalation of lithium ions, such as LiMn₂O₄, LiCoO₂, LiNiO₂, LiFeO₂, V₂O₅, TiS, MoS, or the like. The conductive material may be carbon black or graphite fine particles. Examples of the binder include vinylidene fluoride/hexafluoropropylene copolymer, polyvinylidene fluoride (PVDF), polyacrylonitrile, polymethylmethacrylate, polytetrafluoroethylene, mixtures thereof, and a styrene butadiene rubber polymer. The solvent may be N-methyl-pyrrolidone, acetone, water, or the like. The amounts of the cathode electrode active material, the conductive material, the binder, and the solvent used in the manufacture of the lithium battery may be those generally used in the art.

Any separator that is commonly used for lithium batteries may be used. In particular, the separator may have low resistance to the migration of ions in an electrolyte and may have an excellent electrolyte-retaining ability. Examples of the separator include glass fiber, polyester, TEFLON, polyethylene, polypropylene, polytetrafluoroethylene (PTFE), or combinations thereof. The material that forms the separator may be in non-woven or woven fabric form. More specifically, a windable separator including polyethylene, polypropylene or the like may be used for a lithium ion battery. A separator that retains a large amount of an organic electrolytic solution may be used for a lithium-ion polymer battery.

The separator may be in the form of a separator film formed on an electrode. To form a separator film, a polymer resin, a filler, and a solvent may be mixed to prepare a separator composition. Then, the separator composition is directly coated onto an electrode, and then dried to form the separator film. Alternately, the separator composition may be cast onto a separate support, dried, detached from the separate support, and laminated onto an upper portion of an electrode, thereby forming a separator film

A polymer resin that is commonly used for binding electrode plates may be used to form the separator film. Examples of the polymer resin include a vinylidenefluoride/hexafluoropropylene copolymer, polyvinylidene fluoride, polyacrylonitrile, polymethylmethacrylate or mixtures thereof.

In the electrolyte solution, the solvent selected from the group consisting of propylene carbonate, ethylene carbonate, fluoroethylene carbonate, diethyl carbonate, methyl ethyl carbonate, methyl propyl carbonate, butylene carbonate, benzonitrile, acetonitrile, tetrahydrofuran, 2-methyltetrahydrofuran, γ-butyrolactone, dioxolane, 4-methyldioxorane, N,N-dimethylformamide, dimethyl acetamide, dimethylsulfoxide, dioxane, 1,2-dimethoxyethane, sulfolane, dichloroethane, chlorobenzene, nitrobenzene, dimethyl carbonate, methyl isopropyl carbonate, ethyl propyl carbonate, dipropyl carbonate, dibutyl carbonate, diethylene glycol, dimethyl ether, and mixtures thereof, may be added to a lithium salt such as LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO2)(C_{y}F_{2y+1}SO₂) (where x and y are each independently a natural number), LiCl, LiI, or mixtures thereof.

Similarly, an anode plate may be manufactured using the same method described above for forming the cathode plate, except using anode active material instead of a cathode active material. The separator is interposed between the cathode plate and the anode plate to form an electrode assembly. The electrode assembly is wound or folded and then sealed in a cylindrical or rectangular battery case. Then, an organic electrolyte solution is injected into the battery case to complete the manufacture of a lithium ion battery. Alternatively, a plurality of such electrode assemblies may be stacked in a bi-cell structure and impregnated with an organic electrolyte solution. The resultant is put into a pouch and is sealed, thereby completing the manufacture of a lithium ion polymer battery.

Also, a plurality of electrode assemblies may be stacked to form a battery pack, and the battery pack may be used as an electric vehicle battery, which requires high temperature and high power generation.

A method of manufacturing the complex anode active material according to an embodiment includes: mixing MXₙ and LiOH and stirring the mixture to manufacture an oxide precursor including lithium; adding the oxide precursor including lithium to a member formed of a material alloyable with lithium and stirring and drying the mixture; and heat treating the dried resultant. Here, M is a metal, X is a halogen atom or C1 to C7 alkoxy, and n is an integer in a range of 3 to 6.

The mixing of the MXₙ and LiOH and the stirring of the mixture to manufacture the oxide precursor including lithium may be performed by adding an organic solvent to the MXₙ and LiOH. Examples of the organic solvent include tetrahydrofuran, methanol, ethanol, isopropanol, butanol, and the like, but are not limited thereto.

According to an embodiment, M may be selected from the group consisting of Al, Si, Ti, and Zr. The material alloyable with lithium may be selected from the group consisting of Si, SiOₓ (here, 0<x<2), an Si alloy, Sn, SnOₓ (here, 0<x<2), an Sn alloy, or mixtures thereof.

According to an embodiment, the member formed of a material alloyable with lithium may be scattered by ultrasonic waves in an alcohol solvent. The alcohol solvent may be a C1 to C4 lower alcohol such as, for example, ethanol or isopropanol. However, the alcohol solvent is not limited thereto. The member formed of a material alloyable with lithium may have a size of about 5 to about 10,000 nm.

According to an embodiment, the adding of the oxide precursor including lithium to a member formed of a material alloyable with lithium and stirring and the drying of the mixture may be performed at a temperature in a range of room temperature to about 90° C. under atmospheric pressure or under a lower pressure. In this temperature range, the oxide precursor including lithium may not be affected and the added solvent or a solvent which may be present may be efficiently removed.

Then, heat treating is performed. According to an embodiment, heat treating of the dried resultant may be performed at a temperature in a range of about 400 to about 1200° C. The heat treatment may be performed under a stable atmosphere, such as, for example, an atmosphere including an inert gas such as N₂ or a noble gas such as He, Ne, or Ar.

In the heat treatment process, MXₙ reacts with itself to form an inorganic polymer form. The Li⁺ in LiOH may participate in the reaction or may be movable in the inorganic polymer (namely, the oxide including lithium) represented by the formula LiₐM_{b}O (b/a=ranges from about 0.5 to about 2).

When the heat treatment process is performed at a temperature in a range of about 400 to about 1200° C., an anode using the anode active material has excellent performance.

The embodiments are described in more detail with reference to Examples and Comparative Examples below. The Examples and Comparative Examples are for illustrative purposes only and are not intended to limit the scope of the invention

### Manufacture of Anode Active Material

### EXAMPLE 1

Coating a LiₓAl_{y}O Precursor onto Si Particles

6.6 g of a methylene chloride solution of 1.0 M Aluminum tri-sec-butoxide (Al[OCH(CH₃)C₂H₅]₃, Aldrich), 0.12 g of LiOH, and 5 g of ethanol were mixed in a 50 ml vial, and the mixture are stirred for 24 hours to manufacture an oxide precursor including lithium. 0.6 g of Si particles having a diameter of about 300 nm and 6 g of ethanol are mixed in a 50 ml vial, and then, the Si particles are scattered using ultrasonic waves for 1 hour. 2.349 g of the oxide precursor including lithium are added to the Si and ethanol mixture, and the added resultant is stirred in a bath at 60° C. and dried. The dried resultant is heat treated at 850° C. under a nitrogen atmosphere to complete the manufacture of an anode active material.

### EXAMPLE 2

Coating a LiₓSi_{y}O Precursor onto Si Particles

2.08 g of silicon tetraethoxide (Si(OC₂H₅)₄, Aldrich) and 0.234 g of LiOH are mixed in a 50 ml vial and are stirred for 24 hours to manufacture an oxide precursor including lithium. 0.45 g of Si particles having a diameter of about 300 nm and 6 g of ethanol are mixed in a 50 ml vial, and the Si particles are scattered using ultrasonic waves for 1 hour. 0.155 g of the oxide precursor including lithium is added to the Si and ethanol mixture and the added resultant is stirred in a bath at 60° C. and dried. The dried resultant is heat treated at 850° C. under a nitrogen atmosphere to complete the manufacture of an anode active material.

### EXAMPLE 3

Coating a LiₓTi_{y}O Precursor onto Si Particles

12.75 g of titanium butoxide (Ti(OC₄H₉)₄, Aldrich) and 0.756 g of LiOH are mixed in a 50 ml vial and are stirred for 24 hours to manufacture an oxide precursor including lithium. 0.5 g of Si particles having a diameter of about 300 nm and 6 g of ethanol are mixed in a 50 ml vial and the Si particles are scattered using ultrasonic waves for 1 hour. 0.2184 g of the oxide precursor including lithium is added to the Si and ethanol mixture and the added resultant is stirred in a bath at 60° C. and dried. The dried resultant is heat treated at 850° C. under a nitrogen atmosphere to complete the manufacture of an anode active material.

### EXAMPLE 4

Coating a LiₓTi_{y}O Precursor onto Si Particles

An anode active material is manufactured as in the same manner as in Example 3 except that 0.1034 g of the oxide precursor including lithium is added.

### EXAMPLE 5

Coating a LiₓTi_{y}O Precursor onto Si Particles

An anode active material is manufactured as in the same manner as in Example 3 except that 0.3467 g of the oxide precursor including lithium is added.

### EXAMPLE 6

0.51 g of the dried resultant coating the oxide precursor including lithium manufactured in Example 3, 0.08 g of pitch, and 6 g of tetrahydrofuran are mixed in a 50 ml vial, the mixture particles are scattered using ultrasonic waves for 1 hour, and the mixture is stirred in a bath at 60° C. and dried. The dried resultant is heat treated at 850° C. under a nitrogen atmosphere to complete the manufacture of an active material.

### COMPARATIVE EXAMPLE 1

Coating a TiO₂ Precursor onto Si Particles

0.9 g of Si particles having a diameter of about 300 nm and 10 g of ethanol are mixed in a 50 ml vial and the Si particles are scattered using ultrasonic waves for 1 hour. 0.426 g of titanium butoxide (Ti(OC₄H₉)₄, Aldrich) is added to the mixture and the added resultant is stirred in a bath at 60° C. and dried. The dried resultant is heat treated at 850° C. under a nitrogen atmosphere to complete the manufacture of an anode active material.

### Manufacture of Anode

### EXAMPLE 7

0.03 g of the anode active material manufactured in Example 1 and 0.06 g of graphite (SFG6, TimCal Co.) are mixed in a mortar. 0.2 g of an N-methylpyrrolidone (NMP) solution including 5 parts by weight % of polyvinylidene fluoride (PVDF) (KF1100, Kureha, Japan), which is a binder, is put in the mortar and is mixed. The mixture is coated onto copper (Cu) foil, and the electrode coating is dried for 2 hours in a vacuum oven at 120° C. Then, the dried resultant is rolled using a rolling mill to complete the manufacture of an anode plate.

### EXAMPLE 8

An anode plate is manufactured as in the same manner as in Example 7 except that the anode active material manufactured in Example 2 is used.

### EXAMPLE 9

An anode plate is manufactured as in the same manner as in Example 7 except that the anode active material manufactured in Example 3 is used.

### EXAMPLE 10

An anode plate is manufactured as in the same manner as in Example 7 except that the anode active material manufactured in Example 4 is used.

### EXAMPLE 11

An anode plate is manufactured as in the same manner as in Example 7 except that the anode active material manufactured in Example 5 is used.

### EXAMPLE 12

0.03 g of the active material manufactured in Example 3 and 0.06 g of graphite (SFG6, TimCal Co.) are mixed in a mortar. Then, 0.2 g of a N-methylpyrrolidone (NMP) solution including 5 parts by weight % of polyamide-imide (PAI) (Torlon Co.), which is a binder, is put in the mortar and is mixed. The mixture is coated onto a copper (Cu) foil and the coated foil is dried for 1 hour in an oven at 90° C. Then, the dried resultant is rolled using a rolling mill and is hardened in a vacuum oven at 200° C. for 1 hour to complete the manufacture of an anode plate.

### EXAMPLE 13

An anode plate is manufactured as in the same manner as in Example 12 except that 0.04 g of the active material manufactured in Example 3 and 0.05 g of graphite (SFG6, TimCal Co.) are used.

### EXAMPLE 14

An anode plate is manufactured as in the same manner as in Example 12 except that 0.04 g of the active material manufactured in Example 6 and 0.05 g of graphite (SFG6, TimCal Co.) are used.

### COMPARATIVE EXAMPLE 2

An anode plate is manufactured as in the same manner as in Example 7 except that only Si particles having a diameter of about 300 nm (with no coating) are used as the anode active material.

### COMPARATIVE EXAMPLE 3

An anode plate is manufactured as in the same manner as in Example 7 except that the anode active material manufactured in Comparative Example 1 is used.

### Manufacture of a Battery

The anode plates manufactured in Examples 7-14 and Comparative Examples 2-3 are used as anodes and a Li metal is used as a cathode to manufacture 2016-type coin cells.

### Test for Cycle Characteristics

A charge-discharge evaluation is performed at a voltage in a range of 1.5 V to 0.0005 V for each of the batteries. A mixture solution of ethylene carbonate (EC), in which 1.3 M of LiPF₆ is dissolved, diethylene carbonate (DEC), and fluoro ethylene carbonate (volume ratio of 2:6:2) is used as an electrolyte. In the charge-discharge evaluation, a constant current charge is performed until the voltage of the coin cell reaches 0.0005 V with respect to a Li electrode at a current of 0.1 C. This charge is maintained for about 10 minutes and a constant current discharge is performed until the voltage of the coin cell reaches 1.5 V at a current of 0.1 C. The first charge-discharge capacity and first cycle efficiency are measured. The charging and discharging are repeated, and the charge retention rate is measured after 20 cycles. The results of the test are shown in Table 1 below.

TABLE 1

| | | | | Example | Example | Example | Comparative | Comparative |
|---|---|---|---|---|---|---|---|---|
| | Example 7 | Example 8 | Example 9 | 10¹⁾ | 11²⁾ | 12³⁾ | Example 2 | Example 3 |
| anode | Si/ | Si/ | Si/ | Si/ | Si/ | Si/ | Si particles | Si/ |
| active | LiₓAl_{y}O | LiₓSi_{y}O | LiₓTi_{y}O | LiₓTi_{y}O | LiₓTi_{y}O | LiₓTi_{y}O | that are not | TiO₂ |
| material | | | | | | | coated | |
| (inside/ | | | | | | | | |
| coating) | | | | | | | | |
| Binder | PVDF | PVDF | PVDF | PVDF | PVDF | PAI | PVDF | PVDF |
| First cycle | 1122 | 1184 | 1009 | 1128 | 967 | 1011 | 1147 | 1139 |
| discharge | | | | | | | | |
| capacity | | | | | | | | |
| (mAh/g) | | | | | | | | |
| First cycle | 0.858 | 0.851 | 0.854 | 0.859 | 0.850 | 0.791 | 0.831 | 0.822 |
| efficiency | | | | | | | | |
| Capacity | 75.0 | 68.0 | 86.3 | 84.7 | 85.2 | 96.5 | 44.6 | 33.2 |
| retention | | | | | | | | |
| rate (@20 | | | | | | | | |
| cycles) % | | | | | | | | |

¹⁾Example 10 is different from Example 9 only in that 0.5-fold oxide precursor including lithium is used in the manufacture of the anode active material in Example 9.
²⁾Example 11 is different from Example 9 only in that the amount of the oxide precursor including lithium used in the manufacture of the anode active material in Example 9 is doubled.
³⁾In Example 12, the anode active material manufactured in Example 3 is used and thermosetting Polyamide-imide (PAI) is used as a binder.

Table 1 shows charging and discharging characteristics. Under the same conditions, the batteries employing the anodes including one of the anode active materials as described above, wherein a surface of the anode active material is coated with an oxide including lithium, have excellent first cycle efficiency and capacity retention rate. When pure silicon (with no coating) is used (Comparative Example 2) or when TiO₂ is used to coat the surface of the anode active material (Comparative Example 3), the first cycle efficiency and capacity retention rate is lower than the batteries using the anodes of Examples 7-11, in which an oxide including lithium is used to coat the Si particle. It is regarded that a pure oxide has decreased conductivity and thus cycle characteristics of the oxide are rapidly worsened as more cycles are performed, whereas a complex oxide including lithium has improved conductivity due to lithium included in the complex oxide. In addition, in Examples 9-11, as the amount of oxide including lithium increases, the first cycle efficiency decreases because conductivity is decreased as the amount of oxide increases. Moreover, in Example 12, thermosetting polyamide-imide (PAI) is used as a binder. Although the first cycle efficiency is decreased, the capacity retention rate is greatly increased.

For Examples 13 and 14, the first and 20th cycle efficiency are measured (the results are not shown in Table 1). Comparing Example 13 and Example 14, in which the anode active material includes carbon, the first cycle efficiency and 20th cycle efficiency in Example 13 are respectively 82.3% and 98.7%, and the first cycle efficiency and 20th cycle efficiency in Example 14 are respectively 80.4% and 99.1%. Accordingly, since carbon included in the anode active material has low crystallinity, first cycle efficiency is decreased but as more cycles were performed, the efficiency of the anode active material increases compared to the Comparative Examples.

As described above, according to the one or more of the above embodiments, the lithium secondary battery has high charge/discharge capacity and excellent capacity retention rate.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An anode active material of a lithium secondary battery, comprising:
a member consisting of a material alloyable with lithium; and
a coating layer formed on the member, wherein the coating layer comprises an oxide comprising lithium.

2. The anode active material of claim 1, wherein the material alloyable with lithium is selected from the group consisting of Si, SiOₓ, wherein 0<x<2), an Si alloy, Sn, SnOₓ, wherein 0<x≦2, an Sn alloy, and a mixture thereof.

3. The anode active material of claim 1, wherein the oxide comprising lithium is represented by the formula LiₐM_{b}O, wherein the value of b/a ranges from about 0.5 to about 2, and M is a metal.

4. The anode active material of claim 3, wherein the oxide comprising lithium is generated by mixing MXₙ and LiOH to form an oxide precursor, coating the oxide precursor onto the member consisting of the material alloyable with lithium, and drying and heat treating the coated resultant, wherein M is a metal, X is a halogen atom or a C1 to C7 alkoxy, and n is an integer in a range of 3 to 6.

5. The anode active material of claim 3, wherein M is selected from the group consisting of Al, Si, Ti, and Zr.

6. An anode active material for a lithium secondary battery, comprising:
a member consisting of a material alloyable with lithium; and
a coating layer formed on the member, wherein the coating layer comprises a complex of an oxide comprising lithium and an electrically conductive material.

7. The anode active material of claim 6, wherein the material alloyable with lithium is selected from the group consisting of Si, SiOₓ wherein 0<x<2, an Si alloy, Sn, SnOₓ wherein 0<x≦2), an Sn alloy, and a mixture thereof.

8. The anode active material of claim 6, wherein the electrically conductive material is carbon or a conductive metal.

9. The anode active material of claim 6, wherein the oxide comprising lithium is represented by the formula LiₐM_{b}O, wherein the value of b/a ranges from about 0.5 to about 2 and wherein the electrically conductive material is carbon or a conductive metal.

10. An anode employing the anode active material of a lithium secondary battery of claim 1.

11. An anode employing the anode active material of a lithium secondary battery of claim 6.

12. A lithium secondary battery including the anode of claim 10.

13. A lithium secondary battery including the anode of claim 11.

14. A method of manufacturing an anode active material for a lithium secondary battery, the method comprising:
mixing and stirring MXₙ and LiOH to manufacture an oxide precursor comprising lithium;
adding the oxide precursor comprising lithium to a member comprising a material alloyable with lithium and stirring and drying the resultant; and
heat treating the dried resultant,
wherein M is a metal, X is a halogen atom or a C1 to C7 alkoxy, and n is an integer in a range of 3 to 6.

15. The method of claim 14, wherein M is selected from the group consisting of Al, Si, Ti, and Zr.

16. The method of claim 14, wherein the material alloyable with lithium is selected from the group consisting of Si, SiOₓ wherein, 0<x<2, an Si alloy, Sn, SnOₓ wherein 0<x≦2, an Sn alloy, and a mixture thereof.

17. The method of claim 14, wherein the adding of the oxide precursor comprising lithium to the member comprising a material alloyable with lithium and the stirring and drying of the resultant are performed at a temperature in a range of room temperature to about 90° C. under a pressure equal to or less than atmospheric pressure.

18. The method of claim 14, wherein the heat treating of the dried resultant is performed at a temperature in a range of about 400 to about 1200° C.
